(19) United States
(12) Patent Application Publication
(10) Pub. No.: US 2010/0237812 A1
(43) Pub. Date: Sep. 23, 2010

(54) MOTOR DRIVING APPARATUS

(76) Inventors: Kunio SEKI, Tokyo (JP); Kazutaka INOUE, Kyoto (JP); Hiroyuki KIKUTA, Kyoto (JP); Yuichi OHKUBO, Gunma (JP)

Correspondence Address: TAFT, STETTINIUS & HOLLISTER LLP, SUITE 1800, 425 WALNUT STREET, CINCINNATI, OH, 45202-3957, US

(21) Appl. No.: 12/719,393

(22) Filed: Mar. 8, 2010

(30) Foreign Application Priority Data
Mar. 19, 2009 (JP) 2009-067883

(51) Int. Cl. H02P 6/18

(52) U.S. Cl. 318/400.13; 318/400.35

(57) ABSTRACT

A motor driving apparatus that includes a current changing component, a detecting component, a control component, a back electromotive voltage zero cross detecting component, and a change control component. The current changing component drives a motor. The detecting component detects a point where a value of a magnitude of a current flowing into a coil of the motor changes from a decrease to an increase. The control component controls so that supply of the current to the coil is shut down, when the point is detected and the back electromotive voltage zero cross detecting component detects a zero cross of a back electromotive voltage generated in the coil. The change control component controls so that the direction of the current flowing into the coil changes to a reverse direction opposite to the predetermined direction, when the zero cross is detected.

### CROSS-REFERENCE TO RELATED APPLICATIONS

This application is based on and claims priority under 35 U.S.C. §119 from Japanese Patent Application No. 2009-067883 filed Mar. 19, 2009, the disclosure of which is incorporated by reference herein.

### RELATED ART

1. Field of the Disclosure

The disclosure relates to motor driving apparatuses.

2. Description of the Related Art

In the related art, a single-phase position sensorless permanent magnet motor controller is known (for example, Japanese Patent Application Laid-Open (JP-A) No. 2008-29115).

In this kind of motor controller, a method that calculates a back electromotive voltage (inductive voltage) by a motor current, a terminal voltage, and a motor constant and controls a position is suggested. The single-phase position sensorless permanent magnet motor controller disclosed in JP-A No. 2008-29115 will be described with reference to FIG. 5.

FIG. 5 illustrates an example of a circuit of the single-phase position sensorless permanent magnet motor controller disclosed in JP-A No. 2008-29115. In FIG. 5, reference numeral 11 indicates winding resistance information (winding resistance value) 11, reference numeral 12 indicates inductance information (inductance value), reference numeral 13 indicates a speed control circuit, reference numeral 14 indicates an inductive voltage operation component, and reference numeral 15 indicates a driving signal operation creating circuit.

In the single-phase position sensorless permanent magnet motor controller disclosed in JP-A No. 2008-29115, the back electromotive voltage (inductive voltage) is calculated by the inductive voltage operation component 14 according to the following Equation 1, the driving signal of a single-phase position sensorless permanent magnet motor is calculated by the driving signal operation creating unit 15, and the single-phase position sensorless permanent magnet motor is driven by the driving signal.

$$EO ( θ ) = Et ( θ ) - ( r + L ) \frac{d i ( θ )}{d t} \qquad ( 1 )$$

However, in the single-phase position sensorless permanent magnet motor controller disclosed in JP-A No. 2008-29115, a device that operates the back electromotive voltage (inductive voltage) to detect a motor position is needed, and an operation device, such as a microcomputer, is needed. Since the operation device such as the microcomputer is relatively expensive, the manufacturing cost of the single-phase position sensorless permanent magnet motor controller disclosed in JP-A No. 2008-29115-increases.

### INTRODUCTION TO THE INVENTION

Accordingly, the disclosure has been made to resolve the above-described problem, and it is an object of the disclosure to provide a motor driving apparatus that may decrease manufacturing costs as compared with the related art and change (i.e., switch) the direction of current flowing into the motor with relatively high precision.

According to a first aspect of the disclosure, there is provided a motor driving apparatus including: a current changing component that changes a direction of a current flowing into a coil of a motor and drives the motor; a detecting component that detects a point where a value of the magnitude of the current changes from a decrease to an increase, when the direction of the current flowing into the coil is a predetermined direction; a control component that controls the current changing component such that supply of the current to the coil is shut down, when the point is detected by the detecting component; a back electromotive voltage zero cross detecting component that detects a zero cross of a back electromotive voltage generated in the coil, in a state where the supply of the current to the coil is shut down by the control component; and a change control component that controls the current changing component such that the direction of the current flowing into the coil changes to a reverse direction of the predetermined direction, when the zero cross is detected by the back electromotive voltage zero cross detecting component.

According to the motor driving apparatus of the disclosure, the point where the value of the magnitude of the current changes from a decrease to an increase is detected. When the point is detected, the current changing component is controlled such that supply of the current to the coil is shut down. The zero cross of the back electromotive voltage generated in the coil is detected, in a state where the supply of the current to the coil is shut down. For this reason, the zero cross of the back electromotive voltage is detected without using the operation device such as the microcomputer to operate the back electromotive voltage. Therefore, in the motor driving apparatus according to the disclosure, the manufacturing cost may decrease, and the direction of the current that flows into the motor may be changed (switched) with high precision.

### BRIEF DESCRIPTION OF THE DRAWINGS

Exemplary embodiments of the present disclosure will be described in detail based on the following figures, wherein:

FIG. 1 is a schematic diagram illustrating a configuration of a motor driving apparatus according to an embodiment of the disclosure;

FIG. 2 is a diagram illustrating an example of an output of a back electromotive voltage zero cross detector according to the embodiment;

FIGS. 3A to 3C are diagrams illustrating an example of the operation of the motor driving apparatus according to the embodiment;

FIG. 4 is a schematic diagram illustrating an example of a bottom current detector according to the embodiment; and

FIG. 5 is a circuit diagram of a motor driving circuit according to a related art.

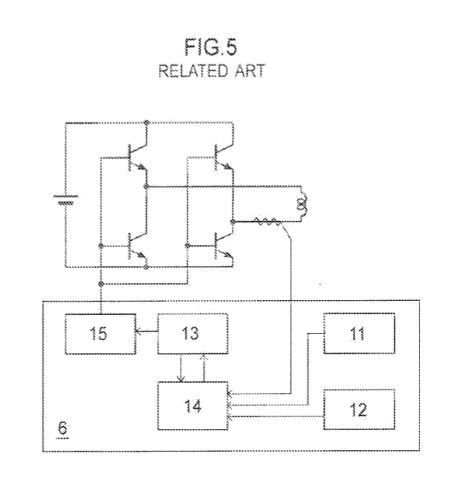

### DETAILED DESCRIPTION

The exemplary embodiments of the present disclosure are described and illustrated below to encompass motor driving apparatuses. Of course, it will be apparent to those of ordinary skill in the art that the preferred embodiments discussed below are exemplary in nature and may be reconfigured without departing from the scope and spirit of the present disclosure. However, for clarity and precision, the exemplary embodiments as discussed below may include optional steps, methods, and features that one of ordinary skill should recognize as not being a requisite to fall within the scope of the present disclosure. Hereinafter, an exemplary embodiment of the present disclosure will be described in detail with reference to the drawings.

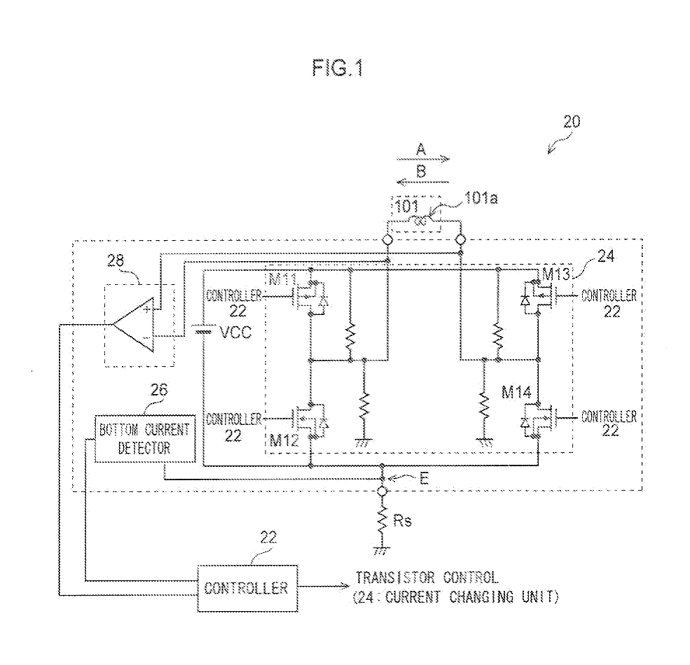

As illustrated in FIG. 1, a motor driving apparatus 20 according to the embodiment includes a controller 22, a current changing unit 24, a bottom current detector 26, and a back electromotive voltage zero cross detector 28.

The controller 22 is connected to the current changing unit 24, the bottom current detector 26, and the back electromotive voltage zero cross detector 28. When a signal output from the bottom current detector 26 is at a high level, the controller 22 outputs an OFF signal to bases of a PMOS transistor M11, an NMOS transistor M12, a PMOS transistor M13, and an NMOS transistor M14 of the current changing unit 24 to be descried in detail below and controls the current changing unit 24 such that supply of a current to a coil 101a of a motor 101 is shut down. When the signal output from the bottom current detector 26 is at a low level and a signal output from the back electromotive voltage zero cross detector 28 is at a high level, the controller 22 outputs an ON signal to the bases of the PMOS transistor M11 and the NMOS transistor M14 and outputs an OFF signal to the bases of the NMOS transistor M12 and the PMOS transistor M13, and controls the current changing unit 24 such that a current flows into the coil 101a in a direction of an arrow A. When the signal output from the bottom current detector 26 is at a low level and the signal output from the back electromotive voltage zero cross detector 28 is at a low level, the controller 22 outputs an ON signal to the bases of the bases of the PMOS transistor M13 and the NMOS transistor M12 and outputs an OFF signal to the bases of the NMOS transistor M14 and the PMOS transistor M11, and controls the current changing unit 24 such that a current flows into the coil 101a in a direction of an arrow B. The controller 22 corresponds to a control component and a change control component of the disclosure.

The current changing unit 24 includes the PMOS transistor M11 and the NMOS transistor M12 of complementary outputs and the PMOS transistor M13 and the NMOS transistor M14 of complementary outputs corresponding to reversed phases of the complementary outputs, with the II bridge configuration. The current changing unit 24 changes the direction of the current flowing into the coil 101a of the motor 101, under the control of the controller 22, and drives the motor 101. That is, in the case where the PMOS transistor M11 and the NMOS transistor M14 are turned on and the case where the PMOS transistor M13 and the NMOS transistor M12 are turned on, a current of a reverse direction is supplied to the coil 101a, and the current changing unit 24 alternately supplies the current to the coil 101a. The motor 101a according to the embodiment is a single-phase full-wave brushless motor.

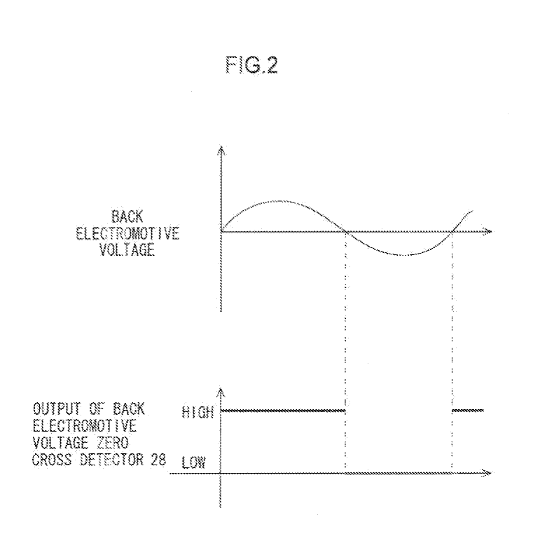

The back electromotive voltage zero cross detector 28 outputs a signal that can detect a zero cross of a back electromotive voltage (inductive voltage) generated in the coil 101a. That is, the back electromotive voltage zero cross detector 28 detects the zero cross of the back electromotive voltage generated in the coil 101a. For example, as illustrated in FIG. 2, the back electromotive voltage zero cross detector 28 outputs a high-level signal to the controller 22 when a waveform of the back electromotive voltage generated in the coil 101a is a positive half wave, and outputs a low-level signal to the controller 22 when the waveform of the back electromotive voltage generated in the coil 101a is a negative half wave. Thereby, the zero cross of the back electromotive voltage generated in the coil 101a can be detected. The back electromotive voltage zero cross detector 28 may output a low-level signal to the controller 22 when the waveform of the back electromotive voltage generated in the coil 101a is a positive half wave, and output a high-level signal to the controller 22 when the waveform of the back electromotive voltage generated in the coil 101a is a negative half wave.

A resistor Rs illustrated in FIG. 1 is a current detection resistor of the current that flows into the motor 101 (specifically, coil 101a).

Although describe in detail below, when a direction of the current flowing into the coil 101a is a predetermined direction (A direction or B direction), the bottom current detector 26 detects a point (bottom current) where a value of the magnitude of the current changes from a decrease to an increase. After the point is detected and the magnitude of the current flowing into the coil 101a becomes the predetermined amount larger than the magnitude of the current flowing into the coil 101a at a point of time when the point is detected (or a predetermined time passes from the detection of the point), the bottom current detector 26 changes a level of a signal, which is output from the bottom current detector 26 to the controller 22, from a low level to a high level.

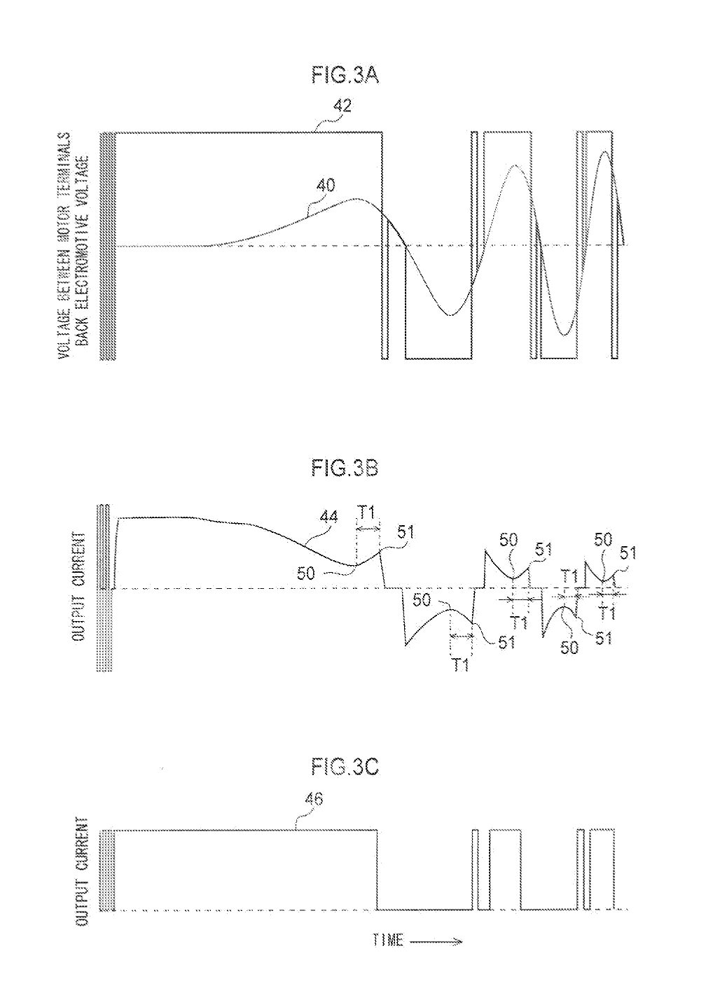

The operation of the motor driving apparatus 20 according to the embodiment will be described with reference to FIGS. 3A to 3C.

FIG. 3A illustrates a waveform of a back electromotive voltage 40 generated in the coil 101a (motor 101) and a voltage 42 applied to the coil 101a (motor 101). FIG. 3B illustrates a waveform of a current 44 that flows into the coil 101a (motor 101). FIG. 3C illustrates a voltage waveform 46 of an output terminal. FIGS. 3a to 3c illustrate waveforms with respect to time from a point of time of the start.

At the time of the start, a start method is fixed by an inductive sense method and a current driving method is determined (refer to a detection method of a stationary position of a three-phase sensorless motor disclosed in EDN Japan 2003. 3, pp 43 to pp 52, in regards to the inductive sense method). A period where a current direction is determined by the inductive sense method appears immediately after the start.

Then, the voltage 42 is applied to the motor 101 (coil 101a), the current flows, and the back electromotive voltage 40 increases. If the back electromotive voltage 40 increases, the motor current 44 decreases by an increase in the back electromotive voltage 40. Then, the position of the motor 101 where the back electromotive voltage 40 decreases due to the magnetization of the motor 101 is generated. If the motor passes through the spot (point) corresponding to the position, an area where the motor current 44 increases by a decrease in the back electromotive voltage 40 is generated.

In the embodiment, the bottom current detector 26 detects a point (bottom position) 50 where a value of the magnitude of the current 44 changes from a decrease to an increase. After a predetermined time T1 passes from the detection of the point 50, an output current is cut off (that is, the controller 22 turns off the PMOS transistor M11, the NMOS transistor M12, the PMOS transistor M13, and the NMOS transistor M14, and controls the current changing unit 24 such that supply of the current to the coil 101a (motor 101) is shut down). In a state where supply of the current to the coil 101a (motor 101) is shut down, when the back electromotive voltage zero cross detector 28 detects the zero cross of the back electromotive voltage 40 generated in the coil 101a and the controller 22 determines that the zero cross of the back electromotive voltage 40 is detected by the back electromotive voltage zero cross detector 28, the controller 22 controls each transistor of the current changing unit 24, such that a direction of the current flowing into the coil 101a (motor 101) changes to a reverse direction the current direction.

Timing where the output current is cut off may be arbitrarily set. For example, using a measurement component such as a counter, after an arbitrary predetermined time T1 passes from the point 50 or at a point 51 where the magnitude of the current 44 (bottom current) flowing into the coil 101a at a point of time when the point 50 is detected increases by several tens of percentages (that is, after the point 50 is detected and the magnitude of the current flowing into the coil 101a becomes the predetermined amount larger than the magnitude of the current 44 flowing into the coil 101a at a point of time when the point 50 is detected), the output current can be cut off.

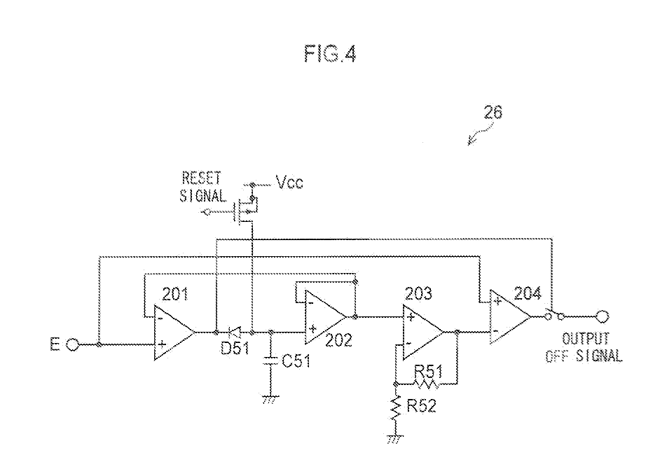

An example of the case in which the output current is cut off at the point 51 where the magnitude of the current 44 (bottom current) flowing into the coil 101a at the point of time when the point 50 is detected increases by several tens of percentages will be described with reference to FIG. 4.

FIG. 4 illustrates an example of the bottom current detector 26. As illustrated in FIG. 4, the bottom current detector 26 includes a capacitor C51, an amplifier 201, a diode D51, a buffer amplifier 202, an amplifier 203, a resistor R51, a resistor R52, and a comparator 204.

If a reset signal to operate the bottom current detector 26 is input from the controller 22, the current is supplied to the capacitor C51 and the capacitor C51 is charged with a voltage until about a power supply voltage Vcc.

Next, if a voltage at a portion E (voltage at both ends of the resistor Rs) (refer to FIG. 1) is input to a positive input terminal of the amplifier 201, a level of the input voltage is lower than a level of a voltage input to a negative input terminal of the amplifier 201. Therefore, an output level of the amplifier 201 becomes a low level, and the charges of the capacitors C51 are discharged thorough the diode D51.

At this time, the voltage of the capacitor C51 is input to the buffer amplifier 202 and an output of the buffer amplifier 202 is fed back to the negative input terminal of the amplifier 201. That is, an input voltage of the negative input terminal of the amplifier 201 becomes a voltage of the capacitor C51.

Next, since the motor current 44 decreases and the voltage at the portion E decreases, similar to the above case, a level of the voltage input to the positive input terminal of the amplifier 201 is lower than a level of the voltage input to the negative input terminal of the amplifier 201. Therefore, the output level of the amplifier 201 is maintained at a low level and the charges of the capacitor C51 are discharged through the diode D51.

At this time, the voltage of the capacitor C51 is input to the buffer amplifier 202 and the output of the buffer amplifier 202 is fed back to the negative input terminal of the amplifier 201. That is, the input voltage of the negative input terminal of the amplifier 201 becomes the decreased voltage of the capacitor C51.

This state transition is continuously executed until the motor current 44 is minimized (bottom position 50).

Next, if the motor current 44 at the bottom position 50 increases, the voltage at the portion E increases. Therefore, the level of the input voltage of the positive input terminal of the amplifier 201 becomes a level that is higher than the level of the input voltage of the negative input terminal of the amplifier 201, the output level of the amplifier 201 becomes a high level, the diode D51 is cut off, the charging and discharging of the capacitor C51 are not made, and the voltage at the bottom position 50 is maintained.

At this time, the voltage of the capacitor C51 is input to the buffer amplifier 202 and the output of the buffer amplifier 202 is fed back to the negative input terminal of the amplifier 201. That is, the voltage at the bottom position 50 becomes a voltage of the capacitor C51.

Even though the motor current 44 increases, the same operation as the above operation is performed.

That is, the output of the buffer amplifier 202 becomes the voltage at the portion E when the bottom current of the motor 101 flows. The output voltage of the buffer amplifier 202 is amplified by the amplifier 203 according to a ratio of resistance values of the resistors R52 and R51. The resistance values of the resistors R52 and R51 are selected such that the current becomes about 1.1 to 1.3 times larger than the bottom voltage.

If the voltage amplified by the amplifier 203 and the voltage at the portion E are compared by the comparator 204, the voltage at the portion E is more than the output voltage of the amplifier 203 at the place (point 51) where the current increases to the current about 1.1 to 1.3 times larger than the bottom current of the motor current 44, and the output level of the comparator 204 becomes a high level from a low level. The output terminal of the comparator 204 is connected to the controller 22, and the controller 22 can recognize a level of the signal output from the comparator 204. That is, the controller 22 can detect the point 51 where the current increases to the current about 1.1 to 1.3 times larger than the bottom current of the motor current 44 (that is, point 51 where the current increases by about 0.1 to 0.3 times as much as the bottom current). The controller 22 may adjust the resistance values of the resistors R51 and R52 to cause the output level of the comparator 204 to become a high level from a low level at the point 50, such that the point 50 can be detected.

At this time, as described above, the controller 22 outputs an OFF signal to the bases of the PMOS transistor M11, the NMOS transistor M12, the PMOS transistor M13, and the NMOS transistor M14 of the current changing unit 24, when the level of the signal output from the bottom current detector 26 is a high level, and controls the current changing unit 24 such that supply of the current to the coil 101a of the motor 101 is shut down. Thereby, the current that flows into the motor 101 (coil 101a) is cut off. If the current that flows into the motor 101 (coil 101a) is cut off, the back electromotive voltage of the motor 101 (coil 101a) can be easily detected, and the zero cross of the back electromotive voltage is detected by the back electromotive voltage zero cross detector 28. The controller 22 sets a mode to a mode where the current is flown again, from the detected zero cross point. Hereinafter, the operation similar to the above will be repeated.

As described above, according to the motor driving apparatus 20 in the embodiment, if the motor current 44 is monitored and the bottom current is detected, the direction of the output current can be switched (changed). Accordingly, according to the motor driving apparatus 20 in the embodiment, since the operation device such as the microcomputer to operate the back electromotive voltage is not used, the manufacturing cost can decrease, and the direction of the current that flows into the motor can be changed (switched) with high precision.

In the above case, the full-bridge output stage circuit having the format of the complementary outputs of the PMOS and NMOS transistors that function as the power transistors of the motor driving circuit has been described. However, the same effect can be obtained in a bootstrap circuit where an NMOS transistor is used as a high-side power transistor and a gate voltage thereof is obtained, the NMOS-NMOS full bridge output format using a charge pump or another power supply voltage supply method or another output format such as an output stage using a bipolar transistor.

Following from the above description and embodiment, it should be apparent to those of ordinary skill in the art that, while the foregoing constitutes an exemplary embodiment of the present disclosure, the disclosure is not necessarily limited to this precise embodiment and that changes may be made to this embodiment without departing from the scope of the invention as defined by the claims. Additionally, it is to be understood that the invention is defined by the claims and it is not intended that any limitations or elements describing the exemplary embodiment set forth herein are to be incorporated into the interpretation of any claim element unless such limitation or element is explicitly stated. Likewise, it is to be understood that it is not necessary to meet any or all of the identified advantages or objects of the disclosure discussed herein in order to fall within the scope of any claims, since the invention is defined by the claims and since inherent and/or unforeseen advantages of the present disclosure may exist even though they may not have been explicitly discussed herein.

What is claimed is:

1. A motor driving apparatus comprising:
a current changing component that drives and rotates a motor having a coil by changing a direction of a current flowing into the coil of the motor;
a detecting component that detects a point where a value of a magnitude of the current changes from a decrease to an increase, when the direction of the current flowing into the coil is a predetermined direction;
a control component that controls the current changing component so that supply of the current to the coil is shut down, when the point is detected by the detecting component;
a back electromotive voltage zero cross detecting component that detects a zero cross of a back electromotive voltage generated in the coil, in a state where the supply of the current to the coil is shut down by the control component; and
a change control component that controls the current changing component so that the direction of the current flowing into the coil changes to a reverse direction opposite to the predetermined direction, when the zero cross is detected by the back electromotive voltage zero cross detecting component.

2. The motor driving apparatus of claim 1, wherein the control component controls the current changing component so that the supply of the current to the coil is shut down, when a predetermined time passes from the detection of the point by the detecting component.

3. The motor driving apparatus of claim 1, wherein the control component controls the current changing component so that the supply of the current to the coil is shut down, when the point is detected by the detecting component and the magnitude of the current flowing into the coil becomes greater, by a predetermined amount, than the magnitude of the current flowing into the coil at a time when the point is detected by the detecting component.
